(19) United States
(12) Patent Application Publication
(10) Pub. No.: US 2003/0082408 A1
(43) Pub. Date: May 1, 2003

(54) Sheet having a hydrophilic surface

(76) Inventors: Tsuneyoshi Saitoh, Higashine-city (JP); Takeshi Koyama, Tokyo (JP)

Correspondence Address: 3M INNOVATIVE PROPERTIES COMPANY, PO BOX 33427, ST. PAUL, MN, 55133-3427, US

(21) Appl. No.: 10/266,514

(22) Filed: Oct. 8, 2002

(30) Foreign Application Priority Data
Oct. 12, 2001 (JP) 2001-316096
Oct. 8, 2002 (WO) PCT/US02/32174

(51) Int. Cl. G11B 5/66

(52) U.S. Cl. 428/694 BP; 428/694 TP; 428/694 TF; 428/694 R; 428/694 DE

(57) ABSTRACT

There is provided a sheet having a hydrophilic surface that has few surface defects such as cracks on the surface of hydrophilic layer, and thus is suitable for use as the substrate film of adhesive sheet to be used outdoors.

A sheet having a hydrophilic surface having a hydrophilic layer includes a base material and a hydrophilic layer having a layer of a hydrophilic agent tightly adhered to the surface of said base material, and the layer surface is hydrophilic. The layer surface is not a surface exposed when the coated layer of the hydrophilic agent is coated.

### RELATED APPLICATION DATA

This application claims foreign priority to Japanese Patent Application No. 2001-316096 filed Oct. 12, 2001.

### BACKGROUND OF THE INVENTION

1. Field of the Invention

The present invention relates to sheets having a hydrophilic surface useful as a substrate as part of adhesive sheets to be adhered to objects used outdoors (such as walls and window glasses of buildings, and bodies of automobiles, airplanes, and ships). Although the sheets having a hydrophilic surface of the present invention comprise a hydrophilic layer, the hydrophilic layer surface is not exposed during drying. Therefore, hydrophilic layers with few surface defects such as cracks can easily be obtained.

Since adhesive sheets comprising the sheets having a hydrophilic surface of the present invention are provided with the above-mentioned hydrophilic layer, they are particularly suitable for use as exterior decorative sheets and marking films.

2. Description of the Related Art

In general, an adhesive sheet such as an exterior film with an adhesive which is adhered to the surface of an object situated outdoors is provided with a protective layer on its surface in order to improve stain resistance of that surface. The protective layers are generally coated layers containing film-forming resins such as acrylic resins and fluorine-containing copolymers. Further, coatings that form such layers are commercially available. However, the protective layers formed with commercial coatings as described above have relatively high surface water contact angle (generally 70° or above), and were found to show properties described below towards contaminants.

Hydrophilic contaminants (such as mud, sand, dust, and rain drop stains): since the protective layers as described above repel water on the surface, water drops easily roll down, while contaminants deposit on dried trails of residual water drops, and form spots or stains. Moreover, because of low surface hydrophilicity, such contaminants once formed are not easily removed by the natural cleaning function of rain, etc.

Lipophilic contaminants (such as waste gas and smoke): since the protective layer surfaces are highly lipophilic, lipophilic contaminants easily deposit on them.

Therefore, in order to solve the problems described above, the present inventors tried to use protective layers containing hydrophilic agents (hydrophilic layers) as protective films for adhesive sheets. Such coatings have been disclosed in the literature as shown below.

For example, Japanese Patent Laid-Open No. 2001-89721 and No. 08-337771 disclose protective layers consisting of layers prepared by applying coatings containing film-forming resins and hydrophilic agents on objects or surfaces of objects to be coated, and drying. The hydrophilic agents used are compounds with relatively low molecular weights that bleed to the surface of the coated layer, where they generate hydrophilic chemical species through chemical decomposition to provide the coated layer surface with a hydrophilic property. Therefore, the hydrophilic coated layers thus formed can easily reduce a surface water contact angle to less than 70°. Lipophilic contaminants do not deposit much on surfaces with such a sufficiently low water contact angle. On the other hand, hydrophilic contaminants can easily be removed by natural cleaning with rain or by artificial cleaning, since the coated layer surfaces are easily wettable. Thus, contamination resistance against hydrophilic and lipophilic contaminants could be improved. As commercial products of such hydrophilic agents, fluorine-containing polysiloxanes GH-100 and GH-700 from Daikin Industries, Ltd. are known.

Further, Japanese Patent Laid-Open No. 11-267585 discloses protective coating layers comprising hydrophilic coated layers utilizing inorganic oxide-based hydrophilic agents. The protective coating layers disclosed here are formed from clear-coat coatings comprising (A) 30-90% by weight of film-forming resin component, (B) 10-70% by weight of curing agent components, and (C) 1-50% by weight of inorganic-oxide-based hydrophilic agents in ratios of non-volatile components. As the inorganic oxide-based hydrophilic agents of the (C) components mentioned above, organosilicates, organosilicate condensates, inorganic oxide sols (aluminum oxide sol, silicon oxide sol, zirconium oxide sol, antimony oxide sol, etc.) are disclosed. These clear-coat coatings can provide objects with coatings with improved protective effects such as contamination resistance and weather resistance through a combination of cured resins and inorganic oxide-based hydrophilic agents. Such a coating is also disclosed in Japanese Patent Laid-Open No. 09-302257. Further, commercial products of coatings containing such inorganic oxide-based hydrophilic agents such as Belclean-clear from NOF Corporation, etc. are known.

Although these publications disclose direct application of such hydrophilic coatings as described above on goods such as automobile bodies and traffic signals, they do not teach the use of such coated layers as protective layers in adhesive sheets.

Further, Japanese Patent Laid-Open No. 2000-256619 discloses an anti-stain treatment method characterized by applying overcoats (hydrophilic coatings) containing specific silicon compounds or their partially hydrolyzed condensates upon overcoating the surface of an automobile body. The above-mentioned specific silicon compounds are compounds represented by the following general formula (1):

(R₁)m-Si—(O—R₂)n

characterized in that R₁ represents a phenyl group, an alkoxy group, or an alkyl group of 1-18 carbon atoms, R₂ represents an alkyl group of 1-6 carbon atoms, m is an integer of 0-2, n is an integer of 2-4, and n+m is 4, or their partially hydrolyzed condensates. Also, these hydrophilic coatings comprise, for example, mixtures of 100 parts by mass of the specific silicon compound, 0.001-5 parts by mass of a catalyst capable of decomposing the silicon compound, and 10-1000 parts by mass of an organic solvent. In this way, stable overcoated layers can be made hydrophilic and stain resistance can be provided.

As commercial coatings containing such silicon compounds, a hydrophilic agent coating OX-011 from NOF Corporation, etc. is known. These commercial coatings do not teach the use of hydrophilic coated layers as protective layers for adhesive sheets.

### SUMMARY OF THE INVENTION

As described above, hydrophilic coated layers can improve anti-stain properties against hydrophilic and lipophilic contaminants. As the result of the study of the present inventors, however, improvements as described below were obtained from the use of sheets having a hydrophilic surface used as a substrate in an adhesive sheet to be used outdoors, namely, as a laminate sheet having (A) a base material and (B) a hydrophilic layer comprising hydrophilic agents, wherein the layer is tightly adhered to the surface of the base material.

Usually, when a protective layer consisting of hydrophilic layer is formed on a base material, a coating containing a hydrophilic agent is applied onto a major surface of the base material, and is heat-dried. For example, when a hydrophilic coated layer is used as a protective layer for an adhesive sheet, a coating containing hydrophilic agent is continuously applied onto the surface of a base material and heat-dried to form a hydrophilic coated layer. Therefore, the layer is dried rapidly at a relatively high temperature (usually at 80-150° C.) in a short space of time (usually 1-20 minutes); very different from the case where coating is applied on walls of buildings and automobile body surfaces and dried by air drying.

However, such heat drying tends to cause surface defects such as cracks on the surface of the hydrophilic coated layers. Especially with low organic polymer content (20 parts by mass or less of organic polymer for 100 parts by mass of hydrophilic agent) in the hydrophilic coated layer, relatively large openings are left after evaporation of solvents causing surface defects. Such surface defects cause the following disadvantages.

(1) Haze of hydrophilic coated layers determined by lighting from the surfaces of the hydrophilic coated layers is increased. When haze is greater than a certain value, visibility of the printed or colored layers contained in base material or observed through transparent base materials is lowered and outward appearance is damaged. For example, when the printed or colored layer is entirely black or contains relatively large portion of black parts, the black parts appear slightly grayish, degrading the appearance.

(2) Water-resistance of the hydrophilic coating layers is reduced. For example, when used outdoors and exposed to wind and rain, water filters through the cracks into the coated layers and reduces their durability and water resistance. Thus, after being exposed to wind and rain in this manner, water contact angle of surfaces of sheets having a hydrophilic surface become 70° or greater, damaging stain-resistance.

Therefore, the purpose of the present invention is to provide a sheet having a hydrophilic surface that has few surface defects such as cracks on the surface of hydrophilic layer, and thus is suitable for use as the substrate of adhesive sheet for outdoor use.

### BRIEF DESCRIPTION OF THE DRAWINGS

FIG. 1 An illustration showing an example of the sheet having a hydrophilic surface precursor.

FIG. 2 An illustration showing an example of the adhesive sheet precursor.

FIG. 3 An illustration showing the state of release and removal of the process substrate from the adhesive sheet precursor.

### DETAILED DESCRIPTION OF THE PREFERRED EMBODIMENTS

In order to solve the above-mentioned problems, according to the present invention, sheets having a hydrophilic surface were made, said sheets comprising (A) a base material and (B) a hydrophilic layer tightly adhered to the surface of the base material and wherein the surfaces of the layer was not exposed during formation.

In the sheets having a hydrophilic surface of the present invention, the hydrophilic layer of hydrophilic agents is preferably coated on a substrate other than the base material, is transferred to the base material, and tightly adhered to the surface of the base material with the previously-exposed surface of the coated layer in contact with the base material, and the hydrophilic layer transferred to the base is preferably a layer of the hydrophilic agent containing the exposed surface and is formed by complete or partial removal of the coated layer from the substrate.

Further, the hydrophilic agent preferably contains a compound having in its molecule a hydrophilic unit that generates hydrophilic species on hydrolysis, the hydrophilic unit having at least one functional group selected from the group consisting of a siloxane group, a silylene group, a silane compound residue, and a silicate residue; and wherein the contact angle of water on the surface of the hydrophilic layer determined after the layer has been immersed in warm water at 40° C. for 5 days and which was then dried is preferably 35° or above and less than 70°. Further, the base material preferably comprises a layer containing an inorganic oxide-based hydrophilic agent, the surface of the layer containing the inorganic oxide-based hydrophilic agent being the surface of the base material to which the hydrophilic coated layer tightly adheres.

Further, according to the present invention, there is provided a method of manufacture of the sheet having a hydrophilic surface comprising the steps of:

forming a precursor of the sheet having a hydrophilic surface by providing a substrate other than the base material, coating a coated layer comprising the hydrophilic agent on the substrate other than the base material, and then tightly adhering the surface of the base material onto the exposed surface of the coated layer; and

removing the substrate from the precursor, and thus transferring the hydrophilic layer from the substrate to the surface of the base material.

The sheet having a hydrophilic surface of the present invention comprises (A) a base material and (B) a hydrophilic layer comprising a hydrophilic agent, the layer tightly adhering to the base material, the surface of the layer being characterized by not being the surface exposed to drying atmosphere during the drying of the coated layer. Therefore, few surface defects such as cracks are formed on the surface of the hydrophilic layer, since openings from which solvent is removed by heat drying are not present on the surface of hydrophilic layer in the sheet having a hydrophilic surface of the invention. The sheet having a hydrophilic surface of the present invention is suitable for use as the substrate of an adhesive sheet used outdoors, since it has such a hydrophilic layer free from surface defects.

The outermost surface of the hydrophilic layer of the sheet is not the surface exposed during coating of the coated layer formation. The exposed surface is, for example, the outermost surface having contact with drying atmosphere (the air in the oven, etc.) when the coated layer is dried on the substrate.

In a preferable embodiment suitable for formation of the hydrophilic layer surface from the surface other than the exposed surface, the hydrophilic layer is a coated layer of hydrophilic agent, and is coated on a substrate other than the base material, and has an exposed surface, and then the layer is wholly or in part transferred to the base material with the exposed surface facing the surface of the base material. In other words, the hydrophilic layer is formed from a layer consisting of whole or part of the coated layer of the hydrophilic agent coated on the other substrate (usually a process substrate), transferred to the base material with the exposed surface facing the surface of the base material. Further, in another preferable embodiment, the hydrophilic layer is formed from the coated layer of the hydrophilic agent containing the exposed surface that is partially removed. The hydrophilic layer formed in this manner has few surface defects, can effectively raise water resistance, and can minimize layer haze to extremely low levels.

In a preferable example of the present invention, haze of the hydrophilic layer, determined by lighting from the surface of the hydrophilic layer, is 2 or below. Hydrophilic layer haze of more than 2 reduces visibility of printed or colored layer contained in the base material or observed through a transparent base material, and may degrade outward appearance. Especially, when the printed or colored layer is entirely black or contains relatively large portion of black parts, the black parts appear slightly grayish degrading the appearance. From such a point of view, particularly preferable haze is 1 or below.

Further, relatively high transparency of the base material and the haze of 5 or below determined by lighting from the surface of hydrophilic layer are preferable since they prevent the danger of reducing visibility of printed or colored layers observed through the base material and of damaging outward appearance. Especially, when the printed or colored layer is entirely black or contains relatively large portion of black parts, the black parts do not appear grayish and are observed as pure black improving the appearance. From such a point of view, haze of the whole sheet having a hydrophilic surface of 2 or below is especially preferable. Haze values in this patent specification are those determined using a color meter based upon JIS K7105 6.4.

Further, a combination of the hydrophilic layer transferred according to the present invention and the layer (underlayer) containing inorganic oxide-based hydrophilic agent laminated on a base material exhibits the following effects. When a layer containing an inorganic oxide-based hydrophilic agent is laminated on the surface of a base material, the surface of the layer is relatively course. When a coating containing a hydrophilic agent is directly applied on such a layer with such surface coarseness and dried, it is difficult to obtain an even surface of dried coated layer of hydrophilic agent. However, when a dried hydrophilic layer of a hydrophilic agent is transferred and laminated onto a layer containing an inorganic oxide-based hydrophilic agent according to the present invention, flatness of the surface of dried hydrophilic layer of hydrophilic agent can be improved. Further, combination of an underlayer containing an inorganic oxide-based hydrophilic agent and a layer of hydrophilic agent laminated on the underlayer exhibits highly hydrophilic properties and a high stain resistance for a long time.

In a sheet having a hydrophilic surface according to the present invention, it is preferable that the hydrophilic layer comprising a hydrophilic agent tightly adhere to the surface of base material, and is coated on a substrate other than the base material, and that the hydrophilic layer of hydrophilic agent is transferred to the surface of the base material. This is explained in detail along the procedure of method of manufacture described below.

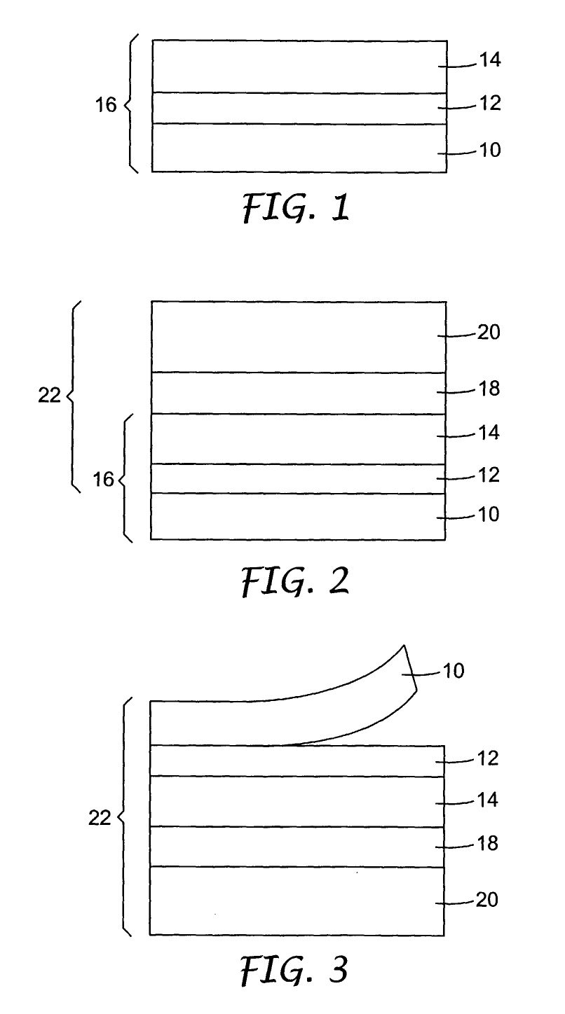

First, a process substrate is provided as the substrate other than the base material, and a coated layer of a hydrophilic agent (the hydrophilic coated layer) 12 is coated on the surface of the process substrate 10, as shown in FIG. 1. The process substrate 10 is a substrate not contained in the sheet having a hydrophilic surface in the end. After the coated layer of the hydrophilic agent 12 is coated on the surface of the process substrate 10, the base material 14 is tightly adhered to or coated on the hydrophilic coated layer 12, as shown in FIG. 1. In the illustrated example, a resin coating containing polymer for forming the base material 14 is applied and cured to form a base material consisting of cured resin coating. Alternatively, a resin layer consisting of a cured resin coating can also be tightly adhered to the hydrophilic coated layer 12 on the process substrate 10, and another layer is tightly adhered to this resin layer to form a base material 14 consisting of a laminate containing this another layer and the resin layer. The procedure of solidification of resin coating is a drying procedure in the case of a coating containing a solvent, and cooling in the case of a molten coating. When the resin coating can be cured, the solidification procedure may also include a curing procedure.

The thickness of the coated layer of the hydrophilic agent is usually 0.004-0.2 μm, and preferably 0.005-0.10 μm. If it is too thin, transfer of coated layer to base material may be difficult, but if it is too thick, flatness of the surface of the hydrophilic layer transferred to the base material film may be reduced resulting in increase of haze of the hydrophilic layer.

In the manner described above, a surface-hydrophilic coated layer precursor 16 can be obtained as a laminate consisting of a process substrate 10, the hydrophilic coated layer 12, one surface of which is covered by the process substrate 10, and a base material 14 which is tightly adhered to the rear surface of the hydrophilic coated layer 12 (see FIG. 1). The sheet having a hydrophilic surface of the present invention can be obtained by releasing the process substrate 10 from the surface of the hydrophilic coated layer 12 to remove it from the precursor 16. Here, the method of manufacture of an adhesive sheet containing such a sheet having a hydrophilic surface as a substrate is explained below.

In the method of manufacture of an adhesive sheet of the present invention, in continuation of the procedure described above, an adhesive layer 18 and a release coated paper (liner) 20 are laminated in this order of layers on the rear surface of the base material 14 of the precursor 16 to form an adhesive sheet precursor 22, as shown in FIG. 2. Subsequently, the process substrate 10 is released and removed off the adhesive sheet precursor 22 as shown in FIG. 3, and thereby the adhesive sheet of the present invention can be obtained.

The adhesive layer 18 and the release coated paper 20 are laminated on the base material 14 in the same way as in the case of an ordinary adhesive sheet. For example, after an adhesive-containing coating is applied on the rear surface of the base material 14 of the precursor 16 and dried to form an adhesive layer 18, a release coated paper 20 can be laminated on the adhesive surface of the adhesive layer 18. Alternatively, an adhesive sheet precursor 22 as shown in FIG. 2 can also be obtained by forming an adhesive layer on the release surface of a release coated paper 20 to prepare an adhesive-coated release paper, and tightly adhering the adhesive layer of the adhesive-coated release paper to the rear surface of the base material 14 of the precursor 16. Ordinary pressure-sensitive adhesives and heat-sensitive adhesives (including hot-melt adhesives) can be used, and curable adhesives may also be used.

On the other hand, the base material preferably contains a layer comprising an inorganic oxide-based hydrophilic agent as the layer which is tightly adhered to the hydrophilic layer that is transferred from the process substrate, as described above. In this case a precursor can be formed as follows. First, after a hydrophilic coated layer is coated on a process substrate as described above, a coating containing an inorganic oxide-based hydrophilic agent is applied on (the rear surface of) this hydrophilic coated layer and solidified to form a second hydrophilic coated layer. In other words, a middle laminate consisting of the first hydrophilic coated layer the surface of which is in contact with the process substrate, and the second hydrophilic coated layer the surface (the surface of the second hydrophilic coated layer) of which tightly adheres to the rear surface of the first hydrophilic coated layer is formed. A base material consisting of a resin layer and the second hydrophilic coated layer can be coated by applying a coating of the resin onto the rear surface of the second hydrophilic coated layer of the middle laminate, and solidifying the resin coating to form the base layer. In the same way as described above, solidification procedure of the resin coating may include drying, cooling, or curing.

Since the sheet having a hydrophilic surface comprising two hydrophilic coated layers formed in this way has layers of hydrophilic agent formed by transferring on the outermost layer of the hydrophilic layers, hydrophilic property is effectively exhibited on the surface of the sheet having a hydrophilic surface by the function of hydrophilic agent in the transferred layers right after use. On the other hand, after relatively long period of use when the transferred layer (the first hydrophilic layer) wore off, the layer of inorganic oxide-based hydrophilic agent underneath (under-layer consisting of the second hydrophilic layer) begins to exhibit hydrophilic property. Thus, high degree of stain resistance can be maintained from right after use for a relatively long time.

The process substrate is not particularly limited so far as it does not damage the effect of the present invention. For example, films formed from organic polymers such as PET film can be used. The thickness of the process substrate is usually 10-300 μm, though not particularly limited. Also, if necessary, release coating may be applied on the surface of the process substrate on which hydrophilic coated layer is coated.

On the other hand, when a process substrate not having a release-coating is used, the coated layer of hydrophilic agent can be easily partially transferred to the base material, leaving part of it on the surface of the process substrate. In other words, in a sheet having a hydrophilic surface having (a) a process substrate and (b) a hydrophilic layer consisting of a hydrophilic agent layer tightly adhered to the surface of the process substrate, after the coated layer of the hydrophilic agent is coated on the surface of the process substrate and a base material is tightly adhered to the coated layer of the hydrophilic agent, part of the coated layer of the hydrophilic agent is transferred to the base material, and a hydrophilic layer consisting of the rest of the coated layer is coated on the process substrate. In such a method of manufacture, similarly to crystal cleavage, the coated layer of the hydrophilic agent forms two new surfaces through cohesive failure of the coated layer, enabling simultaneous manufacture of both a first sheet having a hydrophilic surface containing the base material and a second sheet having a hydrophilic surface containing the process substrate as the base material.

When a sheet having a hydrophilic surface is manufactured in such a way, coated layer containing a hydrophilic agent based upon such silicon compounds as represented by the general formula (1) shown above is preferably used. This enables simultaneous formation of hydrophilic layers on both the surface of the base material and the surface of the process substrate, and effective prevention of surface defects. It is preferable that the coated layer used in this way does not substantially contain organic polymers. When it contains organic polymer, the content is preferably 20 parts by mass or less, and particularly preferably 10 parts by mass or less, for 100 parts by mass of the hydrophilic agent. Also, in order to facilitate partial transfer of the coated layer to the base material leaving the hydrophilic layer of hydrophilic agent on the surface of the process substrate in this way, the process substrate is preferably released at the angle of 20°-180° against the surface of the base material.

When the surface of the process substrate is also made hydrophilic in this way, substrate other than the base material, that is the sheet (film) used as the base material of the second sheet having a hydrophilic surface, can also be used as the process substrate. Incidentally, the above-mentioned release coating means providing a layer containing a release agent such as silicon polymer. Usually, surface water contact angle after release coating is 85-180°.

The hydrophilic layer transferred from the process substrate to form the outermost layer of the sheet having a hydrophilic surface, namely the first hydrophilic layer, is formed by applying a hydrophilic agent. The hydrophilic agent is not particularly limited so far as it can form a coated layer that is transferable from the process substrate to a target of transfer, and can provide the surface of the transferred layer with a hydrophilic property. Preferable hydrophilic agents include compounds having in their molecules hydrophilic units that generate hydrophilic chemical species on hydrolysis, and the hydrophilic unit has at least one functional group selected from a group consisting of a siloxane group, a silylene group, a silane compound residue and silicate residue. The coated layers of such hydrophilic agents have a suitable range of cohesive force, so that transfer from coated substrate (such as process substrates) to the target of transfer (for example, the base material of the sheet having a hydrophilic surface) is especially easy. For example, transfer of coated layers from polymer film surfaces to targets of transfer is possible. Further, high degree of hydrophilic property and good stain resistance can be exhibited from the initial stage of use of sheets having a hydrophilic surface.

Specific silicon compounds represented by the general formula (1) shown above, also disclosed in Japanese Patent Laid-Open No. 2000-256619, or their partially hydrolyzed condensates can be used as the hydrophilic agents. Further, the hydrophilic agents may comprise 100 parts by mass of silicon compounds as shown above and 0.001-5 parts by mass of catalysts capable of hydrolyzing the silicon compounds. Coatings containing such hydrophilic agents are usually formed by adding 10-1000 parts by mass of organic solvents for 100 parts by mass of silicon compounds as shown above.

The coatings for formation of the first hydrophilic coated layers usually have a low organic polymer content. This facilitates transfer of the hydrophilic coated layer from the surface of the process substrate to the base material for formation of the first hydrophilic layer. If an organic polymer is included, the content of the organic polymer is preferably 20 parts by mass or less, and especially preferably 10 parts by mass or less, for 100 parts by mass of the hydrophilic agent.

The organic polymers are preferably single organic polymers capable of forming films after drying of coatings, or resin compositions containing such organic polymers. For example, acrylic, polyester, polyurethane, polyvinyl chloride, silicone (including modified silicones such as silicone polyurea) polymers can be used. Curable polymers are preferable in order to improve the durability of the hydrophilic layers. If a curing agent is added for curing of the polymer, then the organic polymer is a mixture of a curable polymer and a curing agent. Curable polymers are organic polymers having in their molecules functional groups capable of reaction with curing agents, such as hydroxyl, carboxyl, epoxy, and amino groups or photocurable functional groups. Number average molecular weight (polystyrene equivalent by Gel Permeation Chromatography (GPC) determination) of the curable polymers before curing may be in the range of 10,000-500,000, and preferably 15,000-300,000 to enable film-formation of the coatings after drying.

Further, thickness of the first hydrophilic coated layer is not particularly limited so far as it does not damage the effect of the present invention, preferably 0.004-0.02 μm, and especially preferably 0.005-0.10 μm.

Resin films formed from resin coatings can be used as the base materials as described above. Resin coatings usually include simple organic polymers or are such organic polymers. For example, acrylic polymers, polyester, polyurethane, polyvinyl chloride, silicone polymers (including modified silicones such as silicone polyurea polymers) can be used as the organic polymer. Also, in order to improve adhesion of the hydrophilic coated layers (the first and the second hydrophilic coated layers) containing hydrophilic agents, and remove the process substrate without causing surface defects due to damage in the hydrophilic films, plasticizers for organic polymers are preferably contained in the organic polymers. Content of the plasticizers is usually 0.1-30 parts by mass, and preferably 0.5-20 parts by mass, for 100 parts by mass of organic polymers.

Although the base material may contain colorants (pigments, etc.) and may be opaque, it is preferably highly transparent in order to secure good visibility of the printed layers that are observable from the hydrophilic layer side of the sheets having a hydrophilic surface. In such cases, light transmittance is usually 80% or above, and preferably 90% or above. “Light transmittance” herein means the light transmittance determined by the method according to JIS K 7105 “Light transmittance determination method”.

The base material may contain a printed layer. When it contains a printed layer, the printed layer is usually formed on the rear surface of the base material after formation of the precursor. Further, in order to improve coloring property and durability of the printed layer, a print reception layer that functions to receive printing ink or toner may be provided on the rear side of the base material.

The thickness of the base material is usually 10-1,000 μm, and preferably 20-800 μm.

The inorganic oxide-based hydrophilic agent contained in the above-mentioned second hydrophilic coated layer is usually a compound that can make the surface of the second hydrophilic layer hydrophilic, and control its water contact angle within a certain range, containing at least either one of (i) silicon oxide-containing inorganic oxides such as organosilicate compounds (organosilicate, organosilicate condensates, etc.) and (ii) inorganic oxide sol such as silicon oxide sol, aluminum oxide sol, zirconium oxide sol, and antimony oxide sol. As such preferable inorganic oxide-based hydrophilic agents, those disclosed in Japanese Patent Laid-Open No. 09-302257 and No. 11-267585 are useful.

In the case of layers containing inorganic oxide-based hydrophilic agents, it is not usually easy to provide the protective layer surface with sufficient hydrophilic properties (for example, water contact angle of less than 70°) in the initial stage of use (within a month after application), hydrophilic property of the hydrophilic layer surface tends to become sufficient with time, especially after half a year of use, resulting in improvement of stain resistance. In other words, although hydrophilic properties require a long time for development, when they began to exhibit themselves, the hydrophilic layer surface achieves a high degree of stain resistance due to hydrophilic properties for a relatively long period. The main reason for such a delay in the development of highly hydrophilic properties is considered to be due to an increase of hydrophilic property levels with time accompanying chemical change of the hydrophilic agents. Also, when the second hydrophilic coated layer contains a film-forming resin, one of the reasons is considered to be that the inorganic oxide-based hydrophilic agent is buried in the matrix of film-forming resin in the initial stage of use, but is exposed at the surface as surface resin is removed by wearing after continued use.

Inorganic oxides containing organosilicate compounds can be suitably used in the present invention. The organosilicate compounds are used in the form of, for example, silane coupling agents (silicon oxide-based surface treatment agents) supported on the surface of inorganic oxide sols such as silica sol, and organosilicate-containing silica sol of which the surface of the particles is coated with organic polymer. Average particle size of the particles of the sols is usually 100 μm or below.

The second hydrophilic coated layer can be coated with coatings containing an inorganic oxide-based hydrophilic agent and a film-forming resin. The film-forming resin consists of a single organic polymer capable of film formation after drying of the coating or a resin composition containing such an organic polymer. For example, acrylic, polyester, polyurethane, polyvinyl chloride, silicon polymers (including modified silicones such as silicone polyureas) can be used. Curable polymers are preferable to improve durability of the hydrophilic layers. When a curing agent is added to cure the polymer, the organic polymer means a mixture of a curable polymer and a curing agent. Curable polymers are organic polymers having in their molecules functional groups capable of reacting with curing agents such as hydroxyl, carboxyl, epoxy, and amino groups or photo-curable functional groups. Number average molecular weight (polystyrene equivalent by GPC determination) of the curable polymers may be in the range of, usually 10,000-500,000, and preferably 15,000-300,000.

Although the content of inorganic oxide-based hydrophilic agent in the coating for the second hydrophilic coated layer is not particularly limited, it is usually in the range of 1-70 parts be weight, preferably 3-60 parts by weight, and especially preferably 5-50 parts by weight for 100 parts by mass of the film-forming resin. If the amount of the hydrophilic agent is too small, stain resistance may not be maintained for a long period (for example, 6 months or longer). But if the amount is too large, water contact angle of the protective layer surface becomes below a certain range and may cause reduction of the wet-adhesion of the second adhesive sheet (described in detail below) which is laminated on the protective layer surface.

Although a method of formation of the second hydrophilic coated layer is not particularly limited, a coating solution prepared by dissolving or dispersing the whole components of a coated layer such as inorganic oxide-based hydrophilic agent, polymer, and a curing agent in a solvent is preferably applied on the surface of a base material and dried to form a coated layer. Drying is usually carried out at a temperature of 80-150° C. for a period of 1-20 minutes, although the drying temperatures and times are not especially limited.

The sheet having a hydrophilic surface of the present invention can be used as a protective film (or a protective sheet) having on its surface a protective layer containing one layer (the first hydrophilic layer alone) or two or more layers (a plurality of layers including the first and second hydrophilic coated layers). Such protective films having hydrophilic surfaces protect the surfaces of objects by adhesion to the objects, while contamination of the surface of the protective film is effectively prevented, which enabling the appearance and beauty of objects to be maintained.

The water contact angle of the surface of the protective film is usually less than 70°, and preferably controlled in a certain range of 65° or below. If the water contact angle is 65° or below, stain resistance can be effectively improved and maintained for a long time from right after beginning of use. Further, from the standpoint of stain resistance, the lower limit of the water contact angle of the protective film surface is not specifically limited. However, as explained below, in some cases a second adhesive sheet is laminated onto the surface of the protective layer containing the above-mentioned protective film as a base film. In this case, in order to effectively prevent reduction of wet adhesion of the laminated second adhesive sheet, water contact angle of the surface of protective layer is preferably 35° or above.

For example, in some cases, another adhesive sheet (a second adhesive sheet) is laminated onto the surface of the protective layer of the first adhesive sheet which in turn is adhered to the surface of an object used outdoors such as the wall of a building or a signboard. In such cases, generally the first adhesive sheet is first adhered to the surface of the object as an underlayer, and the second adhesive sheet can be cut into the shapes of figures and letters which are then adhered to the surface of the first adhesive sheet to form an adhering structure. In such cases, the second adhesive sheet contacting the hydrophilic layer can adhere with sufficient strength in ordinary conditions, while when the adhering structure is exposed to water such as rain for a long time, adhesion (release resistance) between the surface of the protective layer (the hydrophilic layer) of the first adhesive sheet and the second adhesive sheet, namely wet adhesion may be reduced. Therefore, from such a point of view, water contact angle of the surface of the protective layer is preferably 35° or above.

Further, in order to improve stain resistance but prevent reduction of wet adhesion of the second adhesive sheet in a good balance, the water contact angle of the surface of the protective layer is preferably 40-64°. Incidentally, the above-mentioned water contact angle means initial value right after use.

On the other hand, in order to know if water contact angle of the surface of the protective layer can be maintained within a certain range during use outdoors for a long time, accelerated weathering test methods are preferably used such as a sunshine-weatherometer (WOM) from SUGA Test Instrument Co. Ltd. of Japan, Model WEL-SOM-DC-B-EM. For example, the water contact angle determined after 500 hours of sunshine-weatherometer test is preferably in the above-mentioned range. Further, water contact angle of the surface of protective layer determined after an abrasion test using a T-bar abrasion tester with a wear ring H-22 in the condition of 100 rotation with 1 kg load and then 500 hours of WOM test are carried out on the adhesive sheet before use (usually right before use) is especially preferably in the above-mentioned range according to JIS B 7753. Moreover, water contact angle determined after immersion in warm water of 40° C. for 5 days and drying is preferably 35° or above and below 70°. Water contact angle in this patent specification is that between the surface of the protective layer and water determined using a contact angle meter with a drop of water dropped on the surface of protective layer. The water used is usually purified water obtained by distillation of deionized water.

Further, ultraviolet ray absorbers, stabilizers, and other additives can be added to the protective layer of the protective film in addition to the above-mentioned components for the purpose of improving weather-resistance, stability and other properties.

In case protective films of the present invention are used for protection of graphics display sheets having colored or printed layers, it is preferable to improve transparency of the protective layer to improve visibility of color and design of the graphics. Therefore, light transmittance of the protective film (sheet having a hydrophilic surface for protection of graphics) is usually 80% or above, and preferably 90% or above. Further, thickness of the protective layer is usually 0.002-15 μm, and preferably 0.01-10 μm.

### EXAMPLES

### Example 1

In this example, an adhesive sheet provided with the first hydrophilic film and the second hydrophilic film was prepared as follows.

First, the coating for the first hydrophilic coated layer (OX-011 from NOF Corporation described above) was applied on the surface of a process substrate (50 μm polyethylene terephthalate film from Teijin, and not having a release coating thereon) using a wire-wound rod and dried at 100° C. for 1 minute to form the first hydrophilic coated layer for transfer. The thickness of the first hydrophilic coated layer after drying was 0.1 μm. Haze of the first hydrophilic coated layer was 0.9 and light transmittance was 98%.

Next, the second hydrophilic coated layer was applied on the exposed surface of this first hydrophilic coated layer using a knife coater, and dried at 120° C. for 3 minutes to form a laminate consisting of the first and the second hydrophilic coated layers. Thickness of the second hydrophilic coated layer was 3 μm.

The coating mixture for the second hydrophilic coated layer was prepared by mixing Belclean-Clear No. 5000 from NFO Corporation of Japan with a curable coating containing a poly-functional isocyanate compound. The curable coating used had a ratio of poly-isocyanate/xylene of 70/30 and was obtained from NFO Corporation. The mixing ratio of the hydrophilic coating (nonvolatile component 46% by weight) and the curable coating (nonvolatile component 70% by weight) was 65:35 (weight ratio). The hydrophilic coating used here was one containing organosilicate compound-based hydrophilic agent (a silane coupling agent held on silica sol surface) and an acrylic-polyol-based resin from NFO Corporation.

Next, transparent poly(vinyl chloride) resin paste was applied on the second hydrophilic coated layer of the above-mentioned laminate and dried in two consecutive steps (60° C. for 60 seconds then 200° C. for 90 seconds) to form a resin layer (resin film). This gave a surface-hydrophilic coated layer precursor (a sheet having a hydrophilic surface having process substrate) in which the first hydrophilic coated layer having process substrate tightly adheres on the surface of a base material consisting of the poly(vinyl chloride) resin layer and the second hydrophilic coated layer. The resin layer was 50 μm thick. The haze of the sheet having a hydrophilic surface was 1.0 and its light transmittance was 97%.

Further, an adhesive sheet precursor (an adhesive sheet having process substrate) was prepared by laminating the adhesive surface of a 25 μm thick acrylic adhesive on a paper liner to the rear surface of the base material of the sheet having a hydrophilic surface (the exposed surface of above-mentioned resin layer). Finally, the process substrate was removed from this adhesive sheet precursor to obtain the adhesive sheet of the present example.

### Comparative Example 1

An adhesive sheet of the present example was obtained in the same way as in Example 1 except that the first hydrophilic coated layer was formed by directly coating the hydrophilic coating on the surface of the base material and drying. The haze of the first hydrophilic coated layer was 3.0.

Adhesive sheets of the examples described above were evaluated as follows. The results are shown in Table 1.

Water contact angle: a drop of water was dropped on the surface of the protective layer of the adhesive sheet, and contact angle (degrees) of the protective layer surface with water was determined using a contact angle meter, model CA-Z from Kyowa Interface Science Co., Ltd of Tokyo, Japan, following the procedure described in the manual. The water used was purified water obtained by distilling deionized water. The initial values are those determined with unused adhesive sheets, and the values “after water resistance test” were those determined after the adhesive sheets were immersed in warm water of 40° C. for 5 days and dried.

Observation of appearance: the surface of unused adhesive sheets were observed visually and using an optical microscope. The adhesive sheet of the comparative example looked opaque because microscopic cracks were scattered.

Staining resistance: test pieces prepared by adhering the adhesive sheets on aluminum boards were left outdoors, and stain conditions were visually observed after 2 months. In comparison with adhesive sheets kept indoors as control samples, when little stain was observed, the sheet was evaluated as good, and when staining was observed the sheet was evaluated as not good NG.

TABLE 1

| | | Comparative |
|---|---|---|
| | Example 1 | Example 1 |
| Appearance (initial) | Good | Opaque |
| | Without cracks | With cracks |
| Water contact angle | 49.9 | 46.0 |
| (initial) | | |
| Water contact angle | 54.9 | 70.2 |
| (after water | | |
| resistance test) | | |
| Stain resistance | Good | NG |

### Example 2

A sheet having a hydrophilic surface precursor of the present example was prepared in the same way as in Example 1 except that the first hydrophilic coated layer after drying was 0.03 μm thick, the resin layer was formed directly on the first hydrophilic coated layer without forming the second hydrophilic coated layer, and an adhesive sheet precursor (an adhesive sheet having a process substrate) of the present example was prepared using the same. The adhesive sheet of the present example was obtained by removing the process substrate from the adhesive sheet precursor in the same way as in Example 1. The haze of the sheet having a hydrophilic surface was 0.75 and its light transmittance was 98%.

### Comparative Example 2

An adhesive sheet precursor (an adhesive sheet having a process substrate) of the present example was prepared in the same way as in Example 2 except that the first hydrophilic coated layer was not formed, and the resin layer was formed directly on the surface of the process substrate. The adhesive sheet of the present example was obtained by removing the process substrate from the adhesive sheet precursor in the same way as in example 1.

Water contact angles of the adhesive sheet surfaces and the process substrate surfaces (the surface that was in contact with the adhesive sheet in the precursor) of Example 2 and comparative Example 2 were determined in the same way as in Example 1. The results are shown in Table 2.

In comparative Example 2, there was no hydrophilic layer on either surface of the adhesive sheet or the process substrate, water contact angle was above 70° on both surfaces. On the other hand, from the result of water contact angle determination in Example 1, it was found that part of the coated layer of hydrophilic agent containing the surface exposed during drying was left on the process substrate side, and hydrophilic layer comprising the coated layer left after part of the above-mentioned coated layer was removed on the surface of resin layer of the adhesive sheet. In other words, the hydrophilic layer transferred to the adhesive sheet was the coated layer of hydrophilic agent coated on the process substrate so as to have an exposed surface during drying, and transferred to the above-mentioned base material with the above-mentioned exposed surface facing the surface of the above-mentioned base material.

TABLE 2

| | | Comparative |
|---|---|---|
| | Example 2 | Example 2 |
| Water contact angle | 49.8 | 75.3 |
| (process substrate surface) | | |
| Water contact angle | 49.9 | 74.9 |
| (adhesive sheet surface) | | |

### Example 3

The sheet having a hydrophilic surface precursor of the present example was prepared in the same way as in Example 2 except that the first hydrophilic coated layer after drying was 0.01 μm, and an adhesive sheet precursor (an adhesive sheet having a process substrate) of the present example was prepared using the same. The adhesive sheet of the present example was obtained by removing the process substrate from the adhesive sheet precursor of the present example in the same way as in Example 1. The haze of the sheet having a hydrophilic surface of the present example was 0.6 and its light transmittance was 99%.

As a result of determination of water contact angle of the adhesive sheet surface and the process substrate surface of the present example, it was 49° on the adhesive sheet surface, and 41° on the process substrate surface.

### Example 4

A sheet having a hydrophilic surface precursor of the present example was prepared in the same way as in Example 2 except that the first hydrophilic coated layer after drying was 0.005 μm, and the adhesive sheet of the present example was obtained by removing the process substrate after preparing the adhesive sheet precursor of the present example using the same. The haze of the sheet having a hydrophilic surface of the present example was 0.3 and its light transmittance was 99%.

As a result of determination of water contact angle of the adhesive sheet surface and the process substrate surface of the present example, it was 62° on the adhesive sheet surface, and 62° on the process substrate surface.

As a result of determination of water contact angle of the adhesive sheet surface and the process substrate surface of the present example, it was 62° on the adhesive sheet surface, and 62° on the process substrate surface.

1. A sheet having a hydrophilic surface, comprising:
(A) a base material; and
(B) a hydrophilic layer, said layer comprising a hydrophilic agent, wherein said hydrophilic layer is tightly adhered to a major surface of the base material, and wherein the surface of the hydrophilic layer is hydrophilic, and characterized in that the surface of the hydrophilic layer is not a surface exposed when the layer was coated.

2. The sheet of claim 1, characterized in that said hydrophilic layer is coated as a coated layer with an exposed surface on a substrate other than the base material, the hydrophilic layer is transferred to the base material, and wherein the exposed surface of the hydrophilic coated layer is tightly adhered to the surface of the base material.

3. The sheet of claim 1, characterized in that a coated layer is coated with an exposed surface on a substrate other than the base material, part of the coated layer is transferred to the base material forming the hydrophilic layer, and wherein the exposed surface of the coated layer is tightly adhered to the surface of the base material after transfer.

4. The sheet having a hydrophilic surface of claim 1, characterized in that said hydrophilic agent comprises a compound having in its molecule a hydrophilic unit that generates hydrophilic chemical species on hydrolysis, said hydrophilic unit having at least one functional group selected from the group consisting of a siloxane group, a silylene group, silane compound residue, and a silicate residue.

5. The sheet having a hydrophilic surface of claim 1, characterized in that a water contact angle of said hydrophilic layer surface determined after immersing in warm water of 40° C. for 5 days and drying is 35° or above and less than 70°.

6. The sheet having a hydrophilic surface of claim 1, characterized in that said base material comprises a layer containing an inorganic oxide-based hydrophilic agent, the surface of the layer containing the inorganic oxide-based hydrophilic agent being the surface of said base material to which said hydrophilic layer tightly adheres.

7. The sheet having a hydrophilic surface of claim 1 wherein the sheet is part of a graphic containing one or more colored layers.

8. The sheet having a hydrophilic surface of claim 1 wherein the sheet is part of a marking film.
